(19) United States
(12) Patent Application Publication
(10) Pub. No.: US 2024/0042271 A1
(43) Pub. Date: Feb. 8, 2024

(54) DEVICE FOR EXERCISING ONES TONGUE

(71) Applicant: Charissa Jarrett, Colorado Springs, CO (US)

(72) Inventor: Charissa Jarrett, Colorado Springs, CO (US)

(21) Appl. No.: 17/879,069

(22) Filed: Aug. 2, 2022

(51) Int. Cl. A63B 23/03; A63B 21/02; A61C 7/08

(52) U.S. Cl. CPC A63B 23/032; A63B 21/02; A61C 7/08

(57) ABSTRACT

A tongue exercise device includes a mouthpiece, a depressor, a hinging means, and a restive element. The front portion of the bottom side of the mouthpiece is configured to fit over one's lower row of teeth, while the upper side of the depressor is configured to fit under one's tongue. The hinging means is configured to connect the rear portions of both the depressor's lower side and the mouthpiece's top side. The resistive element is configured to enable the depressor to apply a resistive force to one's tongue when one pushes down with the bottom of one's tongue on the top side of the depressor so as to force it down toward the mouthpiece's top surface.

### BACKGROUND OF THE INVENTION

### 1. Field of the Invention

The present invention relates generally to an oral cavity, exercise device, and more particularly to a device that provides mobility exercises for and related to incorrect tongue placement due to inadequate oral muscular strength such as oral-motor and related disorders.

### 2. Description of the Related Art

The tongue plays a major role in speech sound production and must execute a completely different set of movements and placements than those required for eating and swallowing. There are many muscles and movements that must work together seamlessly to produce clear and correct speech. Poor muscle tone in the tongue or other disorders related to the tongue and mouth muscles can have significant effects on one's ability to speak and communicate clearly and effectively.

In some cases, inadequate strength and placement of the tongue are due to an oral-motor disorder. An oral-motor disorder is defined as the inability to effectively use the mouth for eating, speaking, blowing, chewing, or making specific sounds. Oral motor disorders can be caused by improper programming of the muscles in the mouth, resulting in challenges related to chewing and swallowing, as well as producing clear speech. Low muscle tone can also cause challenges related to speech and language. There are also many other oral cavity issues that can be associated with improper tongue placement, including: (a) snoring and sleep apnea, (b) bite dysfunction, (c) improper swallowing, (d) crowded teeth or front gaps, (e) muscular pain in the mouth, (f) neck pain/tension, (g) headaches, (h) tongue thrust, (i) jaw clenching, and (j) bruxism (side-to-side grinding of teeth). Non-drug and drug therapy plans have been used to treat these disorders.

For example, various devices (e.g., mouth-bite splints, soft bite guards, shore mandibular auto-repositioning appliance) have been introduced to prevent or minimize the symptoms of these disorders. See also U.S. Pat. Nos. 5,855,535; 7,059,332; 7,238,145; 7,890,193; 8,460,159; 9,149,681; 9,867,753; 9,907,690; 11,129,746, and 11,179,232. Meanwhile, the injection of muscle agents, such as botulinum toxin, have also used to treat these symptoms.

Despite this prior art, there continues to be a need for improved devices for treating poor muscle tone, improper tongue placement and related disorders. The present invention seeks to provide an improved oral cavity exercise device.

### BRIEF DESCRIPTION OF THE DRAWINGS

FIG. 1 is a perspective view of a preferred embodiment of the present invention in the form of a device that is placed in one's mouth and used for exercising one's tongue as a treatment for poor muscle tone, improper tongue placement and related disorders.

FIG. 2 is a bottom perspective view of the embodiment shown in FIG. 1.

FIG. 3 is a back or rear perspective view of the embodiment shown in FIG. 1.

FIG. 4 is a front perspective view of the embodiment shown in FIG. 1.

### DESCRIPTION OF THE PREFERRED EMBODIMENT

Recognizing the need for the development of an improved exercise device for treating poor muscle tone, improper tongue placement and related disorders, the present invention seeks to provide a device for providing such an improved treatment. The present invention takes the form of a device that is placed in one's mouth and used for exercising the muscles that control the use of one's tongue, throat, chin and jaw.

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Various aspects, advantages, features and embodiments are included in the following description of exemplary examples thereof, which description should be taken in conjunction with the accompanying drawings. All patents, patent applications, articles, other publications, documents and things referenced herein are hereby incorporated herein by this reference in their entirety for all purposes. To the extent of any inconsistency or conflict in the definition or use of terms between any of the incorporated publications, documents or things and the present application, those of the present application shall prevail.

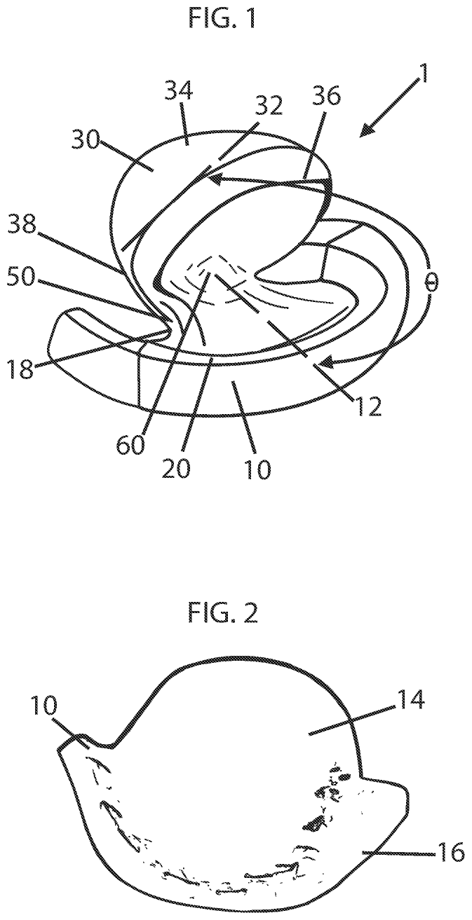

Referring to FIG. 1, there is illustrated a perspective view of a preferred embodiment of the present invention 1. In this embodiment, the present invention takes the form of a device that is placed in one's mouth and used for exercising any combination of the muscles used to control the movement of one's tongue, throat, chin or jaw. The present invention can be further configured to exercise one's upper or lower mouth or both.

It is seen to consist of four elements: a relatively stiff, lower piece or mouthpiece 10, a similarly stiff, upper piece or depressor 30, a hinging means or connector or hinge 50 that connects these pieces at or proximate the rear portions of their boundary edges, and a spring-like, resistive element 60 that is proximate the connector and provides the resistive force that must be overcome to force the depressor downward towards the underlying mouthpiece. The mouthpiece and depressor both have lateral centerlines 12, 32 which assume an initial orientation that is specified by the included angle, θ, between their centerlines. The initial included angle, θ, between the mouthpiece 12 and depressor 32 centerlines is normally set to be in the range of 20-80 degrees depending upon the size of a device user's mouth and physical condition.

As the name of the present invention might suggest, these pieces change their initial orientation as one uses this invention to exercise one's tongue. This occurs because the material of construction of the hinging means is chosen such that it is elastic and thereby allows the depressor to be moved downward with respect to the mouthpiece to which it is attached. Thus, one can press down with the bottom of one's tongue against the depressor's top surface 34 to cause the included angle, θ, between the mouthpiece 12 and depressor 32 centerlines to decrease. After an appropriate interval of time, one decreases the downward pressure being exerted by one's tongue to allow the front 37 of depressor's boundary edge 36 to rise again to assume something approximate to its original location. Repeating this action serves to exercise one's tongue.

FIG. 2 shows that the boundary edge 22 of the mouthpiece is configured to fit over one's lower row of teeth and hold the mouthpiece in place relative to one's lower row of teeth. Meanwhile, the top surface 34 of the depressor is configured to fit under one's tongue. FIG. 4 shows that the depressor's boundary edge 36 near its front portion 37 is rounded so that it takes the same general shape as the front of the boundary edge of one's tongue.

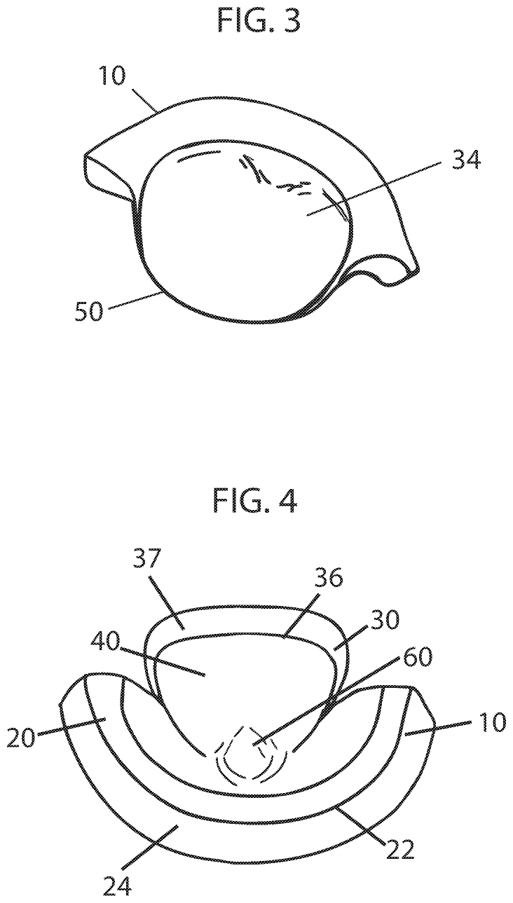

FIG. 3 shows that, for comfort considerations, the average lateral width of the depressor is in the range of 60-80% of the distance between one's rear molars (as indicated by the width of the boundary portion of the mouthpiece's bottom surface at its rear edge). Meanwhile, the rear to front length of the depressor is chosen so as to allow it to be pushed down and approach the mouthpiece's top surface 20 with the front portion 37 of the depressor's boundary edge 36 falling comfortably behind the front portion 24 of the mouthpiece's boundary edge 22. In general, the depressor's top surface is configured to fit under one's tongue (with the tongue resting in proper placement on the roof of one's mouth) and, when forced downward towards the mouthpiece, to generally fit within the space defined by one's lower row of teeth.

As shown in FIGS. 1 and 4, the top surface 20 of the mouthpiece has a concave shape so that the mouthpiece can be of a minimal thickness (e.g., yielding a decrease in the weight of the device) for comfort purposes while the mouthpiece's bottom surface 14 sits proximate to the palate of one's mouth.

In FIGS. 1 and 3, the hinging means or connector of the present invention is seen to be configured to connect the rear portions 38, 18 of the boundary edges of the depressor and the mouthpiece. This hinging means may also be configured to help in enabling the depressor to apply a resistive force to one's tongue when one pushes down with the bottom of one's tongue on the upper side of the depressor.

Many polymers and silicone-like materials, or silicone impression materials, have sufficient elasticity that they are suitable for use in fabricating the present invention. For example, a standard dental putty (i.e., a silicone impression material, consisting of a base and catalyst, and having the initial consistency [before being polymerized] of a putty) was used to form the first prototypes of the present invention. In terms of the material's required elasticity, see the mechanical properties of dental putties such as polyvinyl siloxane (PVS), also called poly-vinyl siloxane, vinyl polysiloxane (VPS), or vinylpolysiloxane.

Depending upon the polymer used to cast the present invention, the spring-like, resistive element 60 (that is proximate the connector and provides the resistive force that must be overcome to force the depressor downward towards the underlying mouthpiece) of the present invention can often be formed by adding additional polymer material to the connector. This can, for example, be accomplished by increasing the thickness between the top and bottom surfaces of the depressor and mouthpiece as one goes from the front to the rear of these elements, and especially proximate the region of the connector. It may even be necessary to add a rounded corner of polymer material on the inside of their connector 50 and oriented such that it separates the depressor's bottom surface 40 from the mouthpiece's top surface 20.

The level of the optimum resistive force that is to be applied to one's tongue by the present invention can be a function of many factors, including: (a) the age of the invention's user, (b) the user's physical and mental condition, and (c) the nature of the disorder with which the user is afflicted. The most common way to test for tongue weakness is with a tongue depressor. Typically, during an oral exam to assess tongue strength, the client is asked to press against the tongue depressor (which is held vertically slightly in front of their lips) with their tongue as hard as they can. The test will then be repeated with the tongue depressor positioned to the left and the right of the lips. Through the evaluation, the quality of a patient's muscle tone within the tongue, as well as overall strength, will then be determined.

The level of the optimum resistive force (for therapeutic purposes) that is to be applied to one's tongue by the present invention can be a function of many factors, including: (a) the age of the one (i.e., the invention's user) seeking the therapeutic treatment provided by the present invention, (b) the user's physical and mental condition, and (c) the nature of the disorder with which the user is afflicted. The most common way to test for tongue weakness is with a tongue depressor. Typically, the patient is asked to press against a tongue depressor (which is held vertically slightly in front of their lips) with their tongue as hard as they can. The patient will then repeat this process with the tongue depressor positioned to the left and the right sides of the tongue.

It should be noted that the elements of the present invention can be shaped and fabricated in many different manners and still fall within the scope of the present invention. For example, the boundary portion 16 of the bottom surface 14 of the mouthpiece that is configured to fit over one's lower row of teeth can be configured to consist of an appropriately shaped cavity (i.e., so that it fits over one's lower row of teeth). In this cavity, there can then be removably situated a bite tray or pad which can be used to customize the bottom surface of this cavity (i.e., one removes the bite tray and bites down upon it to form an impression of one's lower row of teeth; this is then used to form a customized insert that is inserted into the canal to ensure that the mouthpieces fits as comfortably as possible in one's mouth).

The foregoing is considered as illustrative only of the principles of the present invention. Further, since numerous modifications and changes will readily occur to those skilled in the art, it is not desired to limit the invention to the exact construction and operation shown and described herein. Accordingly, all suitable modifications and equivalents may be resorted to, falling within the scope of the invention that is hereinafter set forth in the claims to the invention.

I claim:

1. A device that is used for exercising a user's tongue, said device comprising:
a mouthpiece having a top surface, a bottom surface, and a boundary edge with front and rear portions and that is configured to fit within a user's mouth and lie proximate the bottom of said user's mouth,
a depressor having a boundary edge with a front and a rear portion, and that is configured to fit under said user's tongue and above said mouthpiece,
a hinging means that is configured to connect said rear portions of said boundary edges of said depressor and mouthpiece, and
a resistive element that is proximate said hinging means and configured to enable said depressor to apply a resistive force to a user's tongue when said user pushes down with the bottom of said user's tongue on said depressor to force said depressor downward towards said mouthpiece.

2. The device as recited in claim 1, wherein:
said mouthpiece boundary edge is further configured into the form of a cavity that is shaped to fit over a user's lower row of teeth and hold said mouthpiece in place relative to said user's lower row of teeth,

3. The device as recited in claim 1, wherein:
said depressor further configured to, when forced downward towards said mouthpiece, fit within said user's lower row of teeth.

4. The device as recited in claim 2, wherein:
said depressor further configured to, when forced downward towards said mouthpiece, fit within said user's lower row of teeth.

5. The device as recited in claim 1, wherein:
said mouthpiece top and bottom surfaces having concave curvature.

6. The device as recited in claim 2, wherein:
said mouthpiece top and bottom surfaces having concave curvature.

7. The device as recited in claim 3, wherein:
said mouthpiece top and bottom surfaces having concave curvature.

8. The device as recited in claim 4, wherein:
said mouthpiece top and bottom surfaces having concave curvature.

9. The device as recited in claim 1, wherein:
said mouthpiece and depressor both having a centerline that extends between the rear and front portions of their boundary edges, and
said centerlines having an included angle that is initially set to be in the range of 20-80 degrees when a user has not pressed downward with said user's tongue to force said depressor to move towards said mouthpiece.

10. The device as recited in claim 2, wherein:
said mouthpiece and depressor both having a centerline that extends between the rear and front portions of their boundary edges, and
said centerlines having an included angle that is initially set to be in the range of 20-80 degrees when a user has not pressed downward with said user's tongue to force said depressor to move towards said mouthpiece.

11. The device as recited in claim 3, wherein:
said mouthpiece and depressor both having a centerline that extends between the rear and front portions of their boundary edges, and
said centerlines having an included angle that is initially set to be in the range of 20-80 degrees when a user has not pressed downward with said user's tongue to force said depressor to move towards said mouthpiece.

12. The device as recited in claim 4, wherein:
said mouthpiece and depressor both having a centerline that extends between the rear and front portions of their boundary edges, and
said centerlines having an included angle that is initially set to be in the range of 20-80 degrees when a user has not pressed downward with said user's tongue to force said depressor to move towards said mouthpiece.

13. The device as recited in claim 5, wherein:
said mouthpiece and depressor both having a centerline that extends between the rear and front portions of their boundary edges, and
said centerlines having an included angle that is initially set to be in the range of 20-80 degrees when a user has not pressed downward with said user's tongue to force said depressor to move towards said mouthpiece.

14. The device as recited in claim 6, wherein:
said mouthpiece and depressor both having a centerline that extends between the rear and front portions of their boundary edges, and
said centerlines having an included angle that is initially set to be in the range of 20-80 degrees when a user has not pressed downward with said user's tongue to force said depressor to move towards said mouthpiece.

15. The device as recited in claim 7, wherein:
said mouthpiece and depressor both having a centerline that extends between the rear and front portions of their boundary edges, and
said centerlines having an included angle that is initially set to be in the range of 20-80 degrees when a user has not pressed downward with said user's tongue to force said depressor to move towards said mouthpiece.

16. The device as recited in claim 8, wherein:
said mouthpiece and depressor both having a centerline that extends between the rear and front portions of their boundary edges, and
said centerlines having an included angle that is initially set to be in the range of 20-80 degrees when a user has not pressed downward with said user's tongue to force said depressor to move towards said mouthpiece.

17. The device as recited in claim 2, further comprising:
a removable bite tray that is configured to fit within said mouthpiece cavity.

18. The device as recited in claim 4, further comprising:
a removable bite tray that is configured to fit within said mouthpiece cavity.

19. The device as recited in claim 6, further comprising:
a removable bite tray that is configured to fit within said mouthpiece cavity.

20. The device as recited in claim 8, further comprising:
a removable bite tray that is configured to fit within said mouthpiece cavity.
